(19) United States
(12) Patent Application Publication
(10) Pub. No.: US 2011/0004418 A1
(43) Pub. Date: Jan. 6, 2011

(54) Systems and Devices for Collecting Time and Space Resolved Air Samples

(76) Inventors: Steven N. Chillrud, Tappan, NY (US); James P. Cowin, Kennewick, WA (US); Martin J. Iedema, Richland, WA (US); Beizhan Yan, Nanuet, NY (US); Thomas A. Seim, Richland, WA (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/663,144

(22) PCT Filed: Jun. 5, 2008
(86) PCT No.: PCT/US08/65940

§ 371 Date: Sep. 20, 2010

Related U.S. Application Data
(60) Provisional application No. 60/933,315, filed on Jun. 5, 2007.
(60) Provisional application No. 60/933,398, filed on Jun. 5, 2007.
(60) Provisional application No. 61/015,780, filed on Dec. 21, 2007.

(51) Int. Cl. G01N 1/22; G06F 19/00; G01N 21/25

(52) U.S. Cl. 702/31; 73/863.01; 356/409

(57) ABSTRACT

Systems and devices for collecting time and space resolved air samples are disclosed. In some embodiments, the systems and devices include the following: a housing including an air inlet; a pump positioned to draw air from outside the sampler and into the housing; electronically controllable valves positioned within the housing for receiving air from the pump; air sampling filters for receiving air from the valves; a printed circuit board including a microcomputer, a global positioning satellite tracking device, and programmable memory, the microcomputer being configured to control the valves to allow air to flow to particular air sampling filters to collect an air sample, the microcomputer being configured to record time data and positioning data from the global positioning satellite tracking device simultaneous to collecting the air sample, the data being stored in the programmable memory; and a power source to provide power for the sampler.

### CROSS REFERENCE TO RELATED APPLICATION(S)

This application claims the benefit of U.S. Provisional Application Nos. 60/933,315, filed Jun. 5, 2007, 60/933,398, filed Jun. 5, 2007, and 61/015,780, filed Dec. 21, 2007, which each is incorporated by reference as if disclosed herein in its entirety.

### BACKGROUND

Assessing spatial and temporal variations of the exposure of individual people to airborne particulates (dust) is important for understanding possible health effects upon the individuals, and for identifying the sources of the particles. Examples are industrial settings, where the goal is often to maintain worker health, or in health studies of individuals going about their normal routines. Sources of particles include, for example, diesel traffic, grinding operations in factory, or tobacco and cooking smoke. Current methods of exposure assessment are too cumbersome, noisy and labor-intensive, and provide limited or no time-resolved measurements of key particulate matter (PM) size and compositional characteristics.

Currently available monitoring technology, when used to monitor for time durations on order of 24 hrs and longer require heavy bulky batteries, often causing the personal PM monitors to weigh between 1.5 kg to 3 kg. This is an unpleasant burden for any person, and it becomes prohibitive for younger children. Some studies have tried to get around this in innovative ways: For example, one recent study of grammar-school children in the South Bronx monitored exposures using sampler pumps in wheeled carry-on luggage bags that the children rolled along behind them. Noise from the air pumps used in the monitors also is a severe limitation, as it easily can annoy the subject, or people near the subject. Smaller and quieter designs are needed.

Individual exposure monitors are essential, as many sources of airborne particles are very localized. Monitors that sample the air at a fixed point in a neighborhood, for example, will only provide information about that location. But individuals during each day visit many locations, many with strong local sources of particles. And individual activities (cooking, cleaning, gardening, walking behind a bus, etc) can subject a person to unique and intense exposures to dust. Only via practical personal monitors will we have accurate information about personal exposure.

### SUMMARY

A personal air sampler for collecting time and space resolved air samples is disclosed. In some embodiments, the sampler includes the following: a housing including a plurality of sides, one of the plurality of sides including an air inlet; a pump positioned within the housing, the pump being positioned to draw air from outside the sampler and into the housing via the air inlet; a conduit including a flowmeter, the conduit being positioned within the housing to receive air from the pump; a valve assembly including electronically controllable valves, the valve assembly being positioned within the housing for receiving air from the conduit; air sampling filters positioned within the housing for receiving air from the valve assembly; a printed circuit board including a microcomputer, a global positioning satellite tracking device, and programmable memory, the microcomputer being configured to control the valves to allow air to flow to a one or more of the air sampling filters to collect an air sample, the microcomputer being configured to record time data and positioning data from the global positioning satellite tracking device simultaneous to collecting the air sample, the data being stored in the programmable memory; and a power source joined with the printed circuit board to provide power for the sampler.

A personal air sampler for collecting time and space resolved air samples is disclosed. In some embodiments, the sampler includes the following: a housing including a plurality of sides, one of the plurality of sides including an air inlet; a pump positioned within the housing, the pump being positioned to draw air from outside the sampler and into the housing via the air inlet; a conduit including a flowmeter, the conduit being positioned within the housing to receive air from the pump; a valve assembly including electronically controllable valves, the valve assembly being positioned within the housing for receiving air from the conduit; an air sampling disk positioned within the housing for receiving air from the valve assembly, the air sampling disk including a plurality of air sampling filters; a printed circuit board including a microcomputer, a global positioning satellite tracking device, and programmable memory, the microcomputer being configured to control the valves to allow air to flow to a particular one or particular group of the plurality of air sampling filters to collect an air sample, the microcomputer being configured to record time data and positioning data from the global positioning satellite tracking device simultaneous to collecting the air sample, the data being stored in the programmable memory; and a power source joined with the printed circuit board to provide power for the sampler.

Systems for collecting time and space resolved air samples are disclosed. In some embodiments, the systems include the following: an air sampler module including an air sampler having electronically controllable valves, air sampling filters, and electronic components including a microcomputer, a global positioning satellite tracking device, programmable memory, and a wireless communications chip; a control module including the following: a beacon positioned at a location; a sample schedule software program loaded on the programmable memory including instructions to be executed by the microcomputer, the software program including instructions for controlling the electronically controllable valves to allow air to flow to a particular one of or particular group of the air sampling filters to collect an air sample based on one or more of whether the wireless communications chip senses the beacon, geographical location of the sensor, and predetermined criteria included in the sample schedule software program, the software program including instructions for recording time data and positioning data from the global positioning satellite tracking device simultaneous to collecting the air sample, the data being stored in the programmable memory; a power module including a rechargeable power source for providing power to the system and a base unit for recharging the power source; and a compliance module including the following: a personal beacon device that is configured to be worn by a user; and an activity sensor for sensing changes in orientation of the sampler and acceleration of the sampler, the activity sensor being positioned within the air sampler module housing.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a front isometric view of an air sampler according to some embodiments of the disclosed subject matter;

FIG. 2 is an exploded view of an air sampler according to some embodiments of the disclosed subject matter;

FIG. 3 is an is an exploded view of an air sampler according to some embodiments of the disclosed subject matter; and

FIG. 4 is a diagram of a system according to some embodiments of the disclosed subject matter.

### DETAILED DESCRIPTION

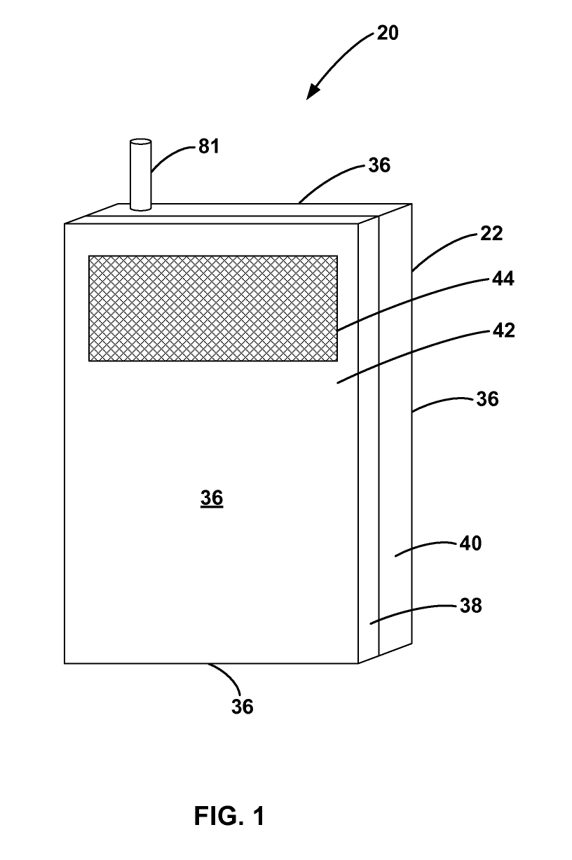

Generally, the disclosed subject matter relates to systems and devices for collecting time and space resolved air samples. As shown in FIGS. 1-4, systems and devices according to the disclosed subject matter include a miniature “smart” personal air sampler 20 for measuring in near real-time black carbon (BC) (a particular component of airborne particulates with soot being one example) and one or more other air pollutants versus time and location. In some embodiments, personal air sampler 20 is adapted to archive samples for advanced laboratory analysis, e.g., mass spectrometric and single particle techniques. In some embodiments, the BC sample is collected via optical adsorption of deposited particulates. Samples of other air pollutants that can be chemo-optically measured are also collected near real-time, e.g., ozone, carbon monoxide.

Referring now to FIGS. 1-3, in some embodiments, personal air sampler 20 includes a housing 22 that contains a pump 24, a conduit 26, a valve assembly 28, air sampling filters 30, a printed circuit board 32, and a power source 34, at least some of which are interconnected.

Housing 22 includes a plurality of sides 36 and is typically, but not always, defined by a first half 38 and a second half 40, which are joined together, e.g., by detent fit, screws, etc. A side 42 of plurality of sides 36 includes an air inlet 44 for allowing the atmospheric air to enter sampler 20. Typically, to keep air inlet 44 near the breathing zone, sampler 20 will be worn on a strap near the chest level of a user. In some embodiments, a short tube (not shown) can be joined with air inlet 44 and clipped to the shirt/blouse, etc. of a user. Housing 22 is typically sized small enough and to permit wide use without inconveniencing users or significantly altering their routines.

Pump 24 is positioned within 22 housing to draw air from outside sampler 20 and into the housing via air inlet 44. The air from outside sampler 20 flows through air inlet 44 and into pump 24 via a path (not shown) that is typically integrated into housing 22 to help minimize the overall size of the sampler. In some embodiments, pump 24 is a miniature, e.g., about 1 cubic inch, non-impact, rotary pump, e.g., the rotary vane pump sold as model G6/01-K-EB12 by ASF-Thomas of Germany or the rotary vane pump sold as model SP 135 FZ by Schwarzer of Germany. In some embodiments, an in-line filter 46 is positioned in housing 22 upstream of pump 24, e.g., a small inline coarse filter to protect the pump from grit.

Conduit 26 is positioned within housing 22 to receive air from pump 24. In some embodiments, conduit 26 includes a flowmeter 48 such as a Honeywell hybrid chip flowmeter or similar. Flow control is generally accomplished via pulse-modulating power to pump 24 in response to readings from flowmeter 48.

Valve assembly 28 includes electronically controllable valves 50, e.g., solenoid valves. Valve assembly 28 is positioned within housing 22 to receive air from conduit 26. In order to safeguard against inadvertent opening/closing of valves 50, e.g., from physical contact, etc., an electronic pulse is sent every few minutes to relatch the valves.

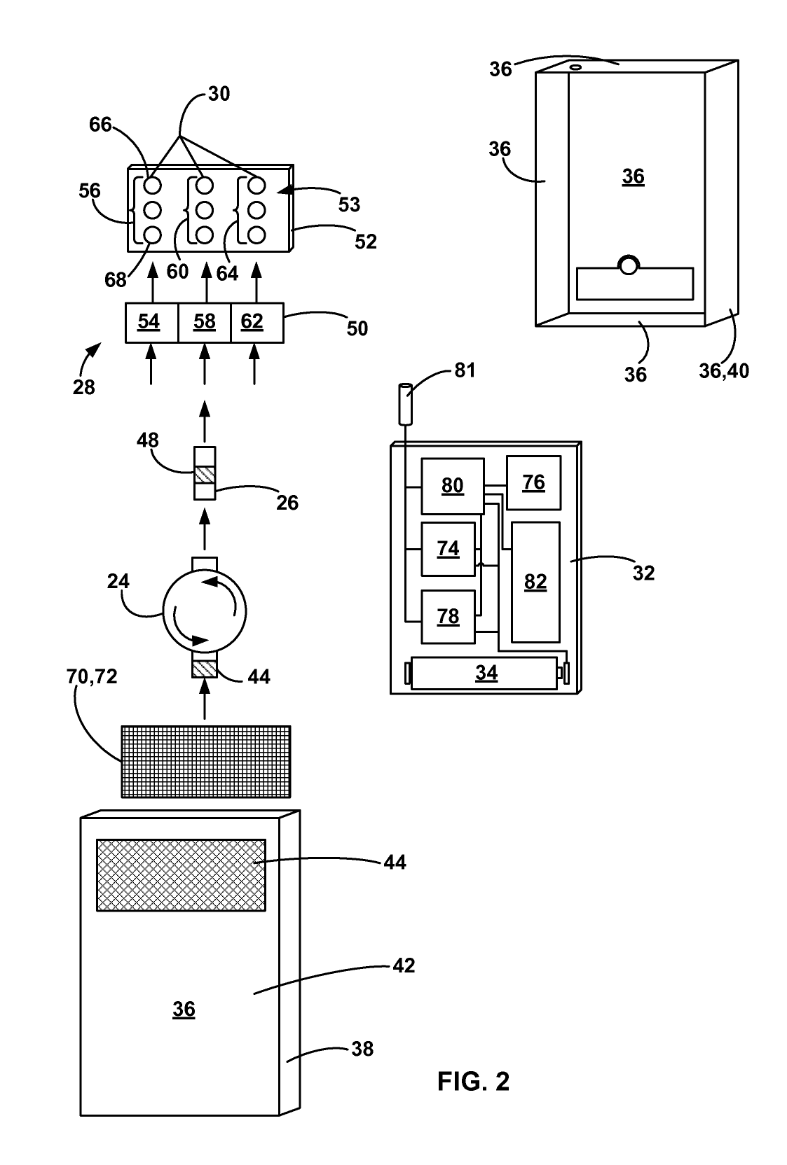

As best shown in FIG. 2, in some embodiments, air sampling filters 30 are formed on one or more air filter cartridges 52, which are positioned within housing 22 to receive air from valve assembly 28. Cartridges 52 can be formed from a thin Teflon strip, e.g., 13 mm in one embodiment, and can include multiple holes 53 for holding a plurality of air sampling filters 30. Each of air sampling filters 30 is mated with one of valves 50 thereby allowing each of the filters to collect an air sample at a specific time and location from a particular one of the valves. For example, at a first location, e.g., a user's home, a valve 54 is opened thereby allowing air to pass through air sampling filters 56, at a second location, e.g., a user's school, a valve 58 is opened thereby allowing air to pass through air sampling filters 60, and at a third location, e.g., places other than user's home or school, a valve 62 is opened thereby allowing air to pass through air sampling filters 64. In order to allow collection of multiple samples at each location, the air sampling filters can includes groups of different types of filters for sampling different types of constituents, e.g., a first filter 66 for collecting a PM₂₅/multi-element sample and a second filter 68 for collecting a BC sample can be used at each of the three micro-environments, i.e., home, school/work, and other.

In some embodiments, first filter 66 is formed from a micro-milled, thin film carbon substrate material and has about a 2 mm diameter. First filter 66 is configured so that it can later be analyzed using for automated single particle analysis to determine particle diameter and elemental composition and for source identification. In some embodiments, first filter 66 is fabricated from a carbon film micromesh material such as the Quantifoil® 1.2/1.3, which is manufactured by Quantifoil Micro Tools GmbH of Germany. Second filter 68 is a mini-quartz filter for collecting particulate matter (PM) for reflectance/transmission measurements as proxies for BC and for qualitative determination of polycyclic aromatic hydrocarbon (PAH)-rich sources. In some embodiments, second filter 68 has a 2 mm diameter and is formed from a Teflon membrane having about 2 micron openings, such as the Teflo filters manufactured by Pall Corporation of East Hills, N.Y., or similar.

Still referring to FIGS. 1-3, in some embodiments, a particulate matter pre-filter 70 is positioned upstream of air sampling filters 30. In some embodiments, pre-filter 70 is a 2.5 micron particle filter, e.g., a pleated wire filter, thin fibrous filter, or similar, that is configured to remove coarse dust from an air sample. In particularly humid regions, particulate matter pre-filter 70 can include a drying agent 72 to improve the performance of the single particle filters, i.e., first filter 66. Drying agent 72 can be formed from a silica gel and that can be regenerated nightly or as required.

Printed circuit board 32 includes a global positioning satellite (GPS) tracking device 74, programmable memory 76, a wireless communications chip 78, and a microcomputer 80 for controlling operation of sampler 20. An antenna 81 can be joined with GPS tracking device 74 and wireless communications chip 78.

GPS device 74 is used to track time and location of outdoor air sampling activities and allows for characterization of mobility patterns as they relate to known pollution sources in the community, e.g., high traffic roadways, and also helps verify proper sampling at different locations. Board-level GPS tracking is used in sampler 20, e.g., the SiRFstarIII and Ublox 5 chipsets. Positions obtained from GPS units are typically accurate to about 7 meters at a 95% confidence level.

Programmable memory 76 includes executable instructions, i.e., software programs that are processed by microcomputer 80 to control sampler 20. Wireless communications chip 78 is used to communicate with a laptop computer or other computing device to program memory 76, e.g., upload software, configure software, etc., and to retrieve data logged and stored in the memory. As discussed in greater detail below, wireless communications chip 78 is also used to sense the presence of other location beacons (not shown). Microcomputer 80 is generally a low-power device that includes built-in communication, a real-time clock, input/output capabilities, etc.

Microcomputer 80 electronically communicates with and controls pump 24, valve assembly 28, power source 34, GPS tracking device 74, programmable memory 76, and wireless communications chip 78. Programmable memory 76 is typically pre-programmed with a set of executable instructions, e.g., one or more software programs, that are used to configure sampler 20 prior to use, control when electronically controllable valves 50 are actuated and air samples are collected, and log data collected.

For example, information related to a user's daily schedule, sampling protocols, data logs, and testing beacons can be pre-programmed or updated and stored in programmable memory 76. In some embodiments, samples are collected according to a user's schedule. For example, programmable memory 76 is programmed to know when a user is scheduled to do routine things, like attending school or work, or programmed according to geographical markers. Based on the programmed schedule, geographical location of the user as indicated by GPS tracking device 74, or a combination of the two, electronically controllable valves 50 are actuated by microcomputer 80 to allow air to flow to a particular one of or particular group of air sampling filters 30 to collect an air sample. Simultaneous to the collection of each air sample, data such as the time, the global position of sampler 20, the air flow rate, filter identification information, etc. are collected, logged, and stored by microcomputer 80 in programmable memory 76.

Still referring to FIGS. 1-3, power source 34 provides power for sampler 20. In some embodiments, a 3.6 V AA lithium battery, such as the LS14500, manufactured by SAFT of France, is used to power sampler 20. Of course, other rechargeable or replaceable power source can be utilized depending on the power requirements of the components included in the air sampler. To conserve battery power, components of sampler 20 are generally only actuated intermittently as required.

In some embodiments, sampler 20 also includes an activity sensor 82 for sensing changes in orientation of the sampler and acceleration of the sampler. In some embodiments, activity sensor 82 includes a 3-axis accelerometer with a ±1 G range. Using a simple algorithm that records the largest change in any axis over the last n-reading, small changes in the orientation of sampler 20 are measured. In combination with other features discussed further below, activity sensor 82 is used to verify that sampler 20 is properly collecting data.

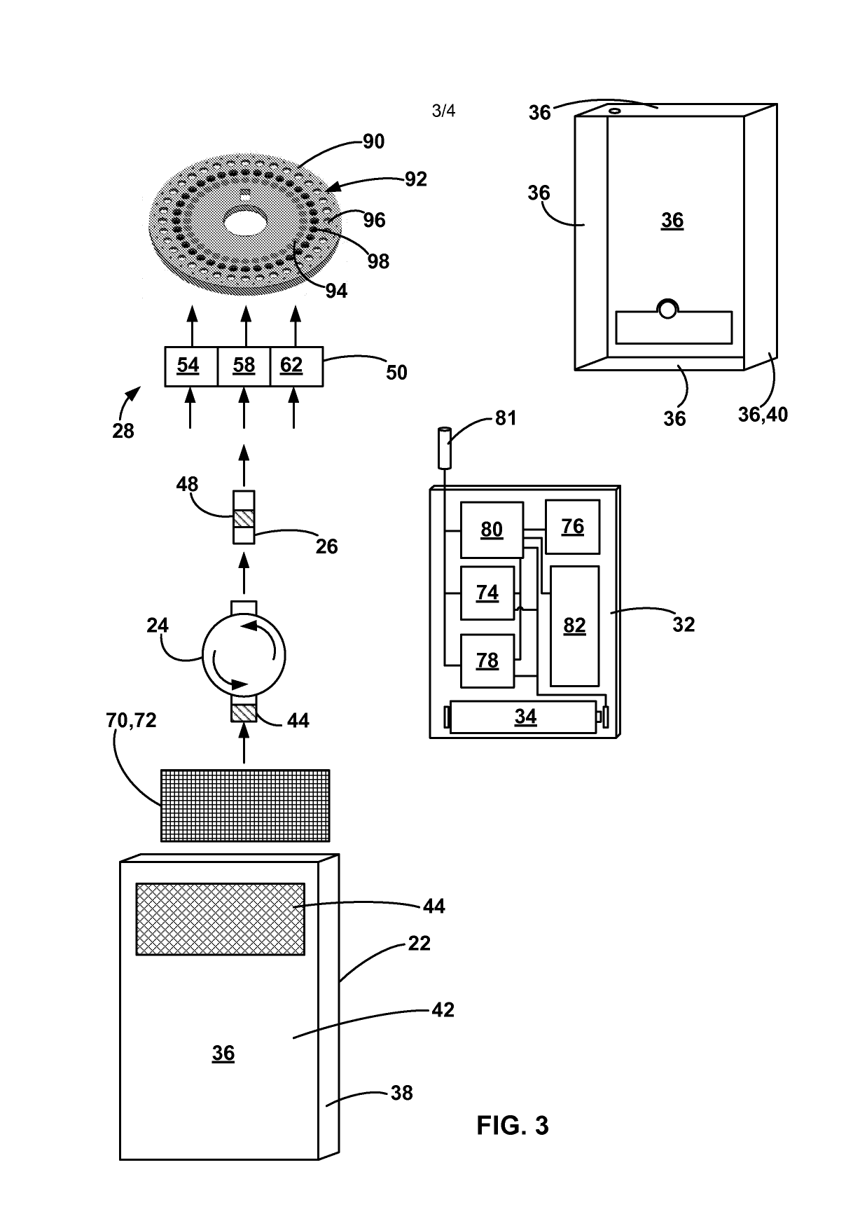

Referring now to FIG. 3, in some embodiments, an air sampling disk 90 is used in place of air filter cartridges 52. Air sampling disk 90 is positioned within housing 22 for receiving air from valve assembly 28 and at least one of electronically controllable valves 50. Air sampling disk 90 includes a plurality of air sampling filters 92. Each of filters 92 is configured to collect an air sample at a specific time and location from a particular one of electronically controllable valves 50. In some embodiments, air sampling filters 92 include colorimetric gas sensors 94, particulate matter membrane filters 96, and single particle filters 98. Air sampling disk 90 is configured so that it can easily be removed from sampler 20 and replaced when the study is over or when all of air sampling filters 92 are fully used. When removed, air sampling disk 90 can be sent to a lab for lab-based analysis by various single particle methods, FTIR, mass spectroscopy, and more extensive spectral analysis. In some embodiments, air sampling disk 90 is assembled by securing cut rings of colorimetric gas sensors 94, particulate matter membrane filters 96, and single particle filters 98, between disks fabricated from PFA or Teflon, or other plastic. Each disk is generally about ½ mm thick and has a diameter of about 43 mm.

Air sampling disk 90 offers flexibility in that the configuration and use of air sampling filters 92 is variable. For example, for an air sampling disk having 36 filters, one can use it to sample 36 times at 1 location, 18 times at 2 locations, 12 times at 3 locations, 9 times at 4 locations, 4 times at 9 locations, etc. Spare filters can also be set aside to allow for additional flexibility in the course of a study. Using data from the GPS tracking device, for 36 positional samples, the sampler can map pollution sources on a coarse 6 by 6 grid.

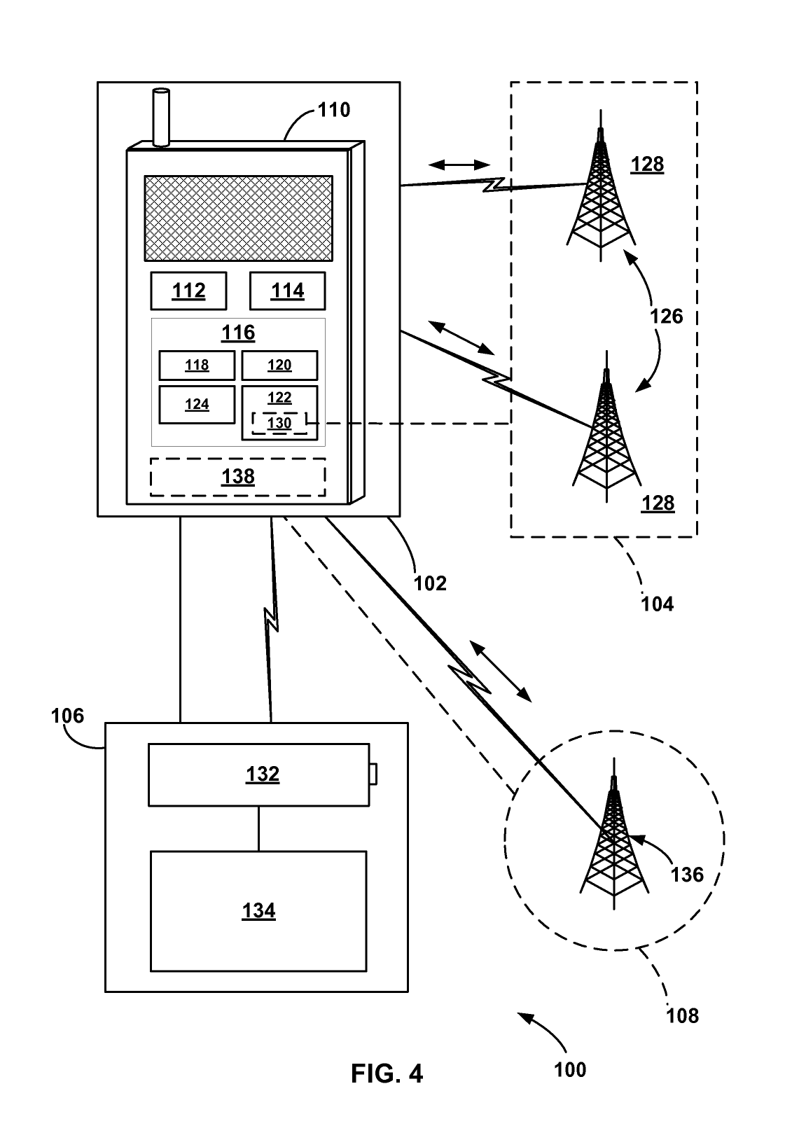

Referring now to FIG. 4, some embodiments of the disclosed subject matter include a system 100 for collecting time and space resolved air samples. System 100 includes an air sampler module 102, a control module 104, a power module 106, and a compliance module 108.

Air sampler module 102 includes an air sampler 110 having electronically controllable valves 112, air sampling filters 114, and electronic components 116 including a microcomputer 118, a global positioning satellite tracking device 120, programmable memory 122, and a wireless communications chip 124.

Control module 104 includes one or more beacons 126 positioned at one or more locations 128 and a sample schedule software program 130 loaded on programmable memory 122. Sample schedule software program 130 includes instructions to be executed by microcomputer 118. For example, in some embodiments, software program 130 includes instructions for controlling electronically controllable valves 112 to allow air to flow to a particular one of or particular group of air sampling filters 114 to collect an air sample based on one or more of (1) whether wireless communications chip 124 senses one of beacons 126, (2) geographical location of air sampler 110 based on data from global positioning satellite tracking device 120, and (3) predetermined criteria included in sample schedule software program 130. As mentioned above, in some embodiments, a first subgroup of air sampling filters 114 is used to collect air samples when the user is at a first location, e.g., home, a second subgroup of the air sampling filters is used to collect air samples when the user is at a second location, e.g., work or school, and a third subgroup of the air sampling filters is used to collect air samples when the user is at locations other than the first and second locations. Software program 130 also includes instructions for recording time data and positioning data from global positioning satellite tracking device 120 simultaneous to collecting an air sample. The data is typically stored in programmable memory 122.

Power module 106 typically, but not always, includes a rechargeable power source 132, e.g., a rechargeable battery, for providing power to system 100. Power module 106 can also include a base unit 134 for recharging power source 132. In some embodiments, base unit 134 can also serve as a data conduit for uploading and downloading data to and from air sampler 102 to and from a computing device or processor external to system 100. If equipped with a wireless transmitter, base unit 134 can also serve as a beacon. Typically, base unit 134 is powered using hardwired AC power, but can also be battery or solar powered for remote locations.

Compliance module 108 includes a personal beacon device 136 that is configured to be worn by a user, e.g., button-sized or similar, and an activity sensor 138 for sensing changes in orientation of air sampler 110 and acceleration of the sample. Personal beacon device 136 typically includes only a microprocessor, battery, and wireless transceiver. A user could wear personal beacon device 136 effortlessly on a lapel. Personal beacon device 136 is configured to indicate and log whether air sampler 110 in close proximity and the air sampler would log when it detects personal beacon device is in close proximity. Activity sensor 138 is positioned in air sampler 110. Compliance module 108 is used to gather data for verifying that users are properly using the samplers and not leaving them “at home,” etc. If a user forgot to wear the air sampler or recharge it, compliance module 108 can alert software program 130 to allow the device to adapt to the situation so as to best serve a study. In addition, one can program it to shift sampling durations or move to spare samples, if high exposures threaten to exceed the dynamic range of the filters.

Although a primary purpose is for compliance, compliance module 108 also allows additional sampling strategies for estimating personal exposures. For example, one or more air samplers 110 could be used as site monitors, e.g., in a home's cooking area. If each family member wears a personal beacon device 136, the fixed-site air sampler 110 can measure the time pattern of particulates and also log the exact time periods that each of the various and individual family members are located in the cooking area, thus allowing exposures to be calculated for all family members including infants.

Systems and methods according to the disclosed subject matter provide advantages and benefits over known systems and methods. Fine particle black carbon (BC) is a byproduct of incomplete combustion of organic matter and can be an important component of airborne particulate matter. Other PM size and compositional metrics can also sharpen our understanding of both source impacts as well as potentially toxic components, but only if they can be easily measured for time and space resolved samples collected via portable, light-weight personal monitors. In addition to potentially widespread utility in epidemiology studies addressing intra-urban exposures to traffic emissions, advanced personal monitors for BC and other PM characteristics would also be valuable in studies addressing indoor exposures to smoke from cooking with biomass fuels—a widespread risk factor for morbidity and mortality in developing countries.

Samplers according to the disclosed subject matter have the flexibility to be readily reprogrammed for differing sampling priorities and resolutions in its mapping of both the time and spatial dependence of the personal exposure. Further, samplers according to the disclosed subject matter will be able to adapt without outside intervention to handle situations during sampling such as: it being left home by the subject; failing to be recharged; or dealing with high exposures that might otherwise exceed the dynamic range of the sampler.

Devices and systems according to the disclosed subject matter make it possible to monitor personal exposures of children and adults with a device small and quiet enough to avoid compromising normal activities, to enable long-term deployment, to collect separate time-resolved samples in relevant exposure micro-environments, and to provide quantitative total BC, bio-mass BC, and estimates of PM2.5 and key multi-elemental and isotope ratio data for use in source characterization.

Devices according to the disclosed subject matter offer the ability to collect samples of airborne PM for laboratory analysis from multiple micro-environments. The ability to use a single sampler to collect personal samples from multiple locations greatly expands the types of questions that can be investigated. Further, it is light and small enough to be used by young children.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A personal air sampler for collecting time and space resolved air samples, said sampler comprising:
a housing including a plurality of sides, one of said plurality of sides including an air inlet;
a pump positioned within said housing, said pump being positioned to draw air from outside said sampler and into said housing via said air inlet;
a conduit including a flowmeter, said conduit being positioned within said housing to receive air from said pump;
a valve assembly including electronically controllable valves, said valve assembly being positioned within said housing for receiving air from said conduit;
air sampling filters positioned within said housing for receiving air from said valve assembly;
a printed circuit board including a microcomputer, a global positioning satellite tracking device, and programmable memory, said microcomputer being configured to control said valves to allow air to flow to one or more of said air sampling filters to collect an air sample, said microcomputer being configured to record time data and positioning data from said global positioning satellite tracking device simultaneous to collecting said air sample, said data being stored in said programmable memory; and
a power source joined with said printed circuit board to provide power for said sampler.

2. The sampler according to claim 1, wherein said air sampling filters include a first plurality of filters for collecting a plurality of air samples at a first location, a second plurality of filters for collecting a plurality of air samples at a second location, and a third plurality of filters for collecting a plurality of air samples at a third location

3. The sampler according to claim 1, further comprising a wireless communications chip joined with said printed circuit board.

4. The sampler according to claim 1, further comprising a particulate matter pre-filter positioned upstream of said air sampling filters.

5. The sampler according to claim 4, wherein said particulate matter pre-filter includes a drying agent.

6. The sampler according to claim 1, further comprising an in-line filter positioned in said housing upstream of said pump.

7. The sampler according to claim 1, further comprising an activity sensor for sensing changes in orientation of said sampler and acceleration of said sampler.

8. The sampler according to claim 1, further comprising a set of executable instructions stored in said programmable memory.

9. The sampler according to claim 8, wherein said set of executable instructions are used to configure said sampler prior to use.

10. The sampler according to claim 8, wherein said set of executable instructions are used to determine when said valves are actuated and air samples are collected.

11. The sampler according to claim 1, wherein said air sampling filters are part of an air sampling disk.

12. The sampler according to claim 1, wherein said air sampling filters include colorimetric gas sensors.

13. The sampler according to claim 1, wherein said air sampling filters include particulate matter membrane filters.

14. The sampler according to claim 1, wherein said air sampling filters include single particle filters.

15. A personal air sampler for collecting time and space resolved air samples, said sampler comprising:
a housing including a plurality of sides, one of said plurality of sides including an air inlet;
a pump positioned within said housing, said pump being positioned to draw air from outside said sampler and into said housing via said air inlet;
a conduit including a flowmeter, said conduit being positioned within said housing to receive air from said pump;
a valve assembly including electronically controllable valves, said valve assembly being positioned within said housing for receiving air from said conduit;
an air sampling disk positioned within said housing for receiving air from said valve assembly, said air sampling disk including a plurality of air sampling filters;
a printed circuit board including a microcomputer, a global positioning satellite tracking device, and programmable memory, said microcomputer being configured to control said valves to allow air to flow to a particular one or particular group of said plurality of air sampling filters to collect an air sample, said microcomputer being configured to record time data and positioning data from said global positioning satellite tracking device simultaneous to collecting said air sample, said data being stored in said programmable memory; and
a power source joined with said printed circuit board to provide power for said sampler.

16. The sampler according to claim 15, wherein said air sampling filters include colorimetric gas sensors.

17. The sampler according to claim 15, wherein said air sampling filters include particulate matter membrane filters.

18. The sampler according to claim 15, wherein said air sampling filters include single particle filters.

19. A system for collecting time and space resolved air samples, said system comprising:
an air sampler module including an air sampler having electronically controllable valves, air sampling filters, and electronic components including a microcomputer, a global positioning satellite tracking device, programmable memory, and a wireless communications chip;
a control module including the following:
a beacon positioned at a location;
a sample schedule software program loaded on said programmable memory including instructions to be executed by said microcomputer, said software program including instructions for controlling said electronically controllable valves to allow air to flow to a particular one of or particular group of said air sampling filters to collect an air sample based on one or more of whether said wireless communications chip senses said beacon, geographical location of said sensor, and predetermined criteria included in said sample schedule software program, said software program including instructions for recording time data and positioning data from said global positioning satellite tracking device simultaneous to collecting said air sample, said data being stored in said programmable memory;
a power module including a rechargeable power source for providing power to said system and a base unit for recharging said power source; and
a compliance module including the following:
a personal beacon device that is configured to be worn by a user; and
an activity sensor for sensing changes in orientation of said sampler and acceleration of said sampler, said activity sensor being positioned within said air sampler module housing.

20. The system according to claim 19, wherein said predetermined criteria included in said sample schedule software program are automatically adjusted depending on a location of said personal beacon device in relation to said air sampler module and data transmitted from said activity sensor to said control module.
